(19) United States
(12) Patent Application Publication
(10) Pub. No.: US 2025/0391202 A1
(43) Pub. Date: Dec. 25, 2025

(54) TAGLESS PAYMENT PLATFORM BASED ON LINKAGE OF MOBILE CARRIERS' BASE STATIONS

(71) Applicant: Sung-ryeol KIM, Gwacheon-si (KR)

(72) Inventor: Sung-ryeol KIM, Gwacheon-si (KR)

(21) Appl. No.: 19/246,677

(22) Filed: Jun. 23, 2025

(30) Foreign Application Priority Data
Jun. 24, 2024 (KR) 10-2024-0082223

(51) Int. Cl. G07B 15/02; G06Q 20/32; G06Q 50/40

(52) U.S. Cl. CPC G07B 15/02; G06Q 20/3224; G06Q 20/3278; G06Q 50/40

(57) ABSTRACT

Disclosed is a tagless payment management apparatus in which boarding and alighting are detected in a tagless manner by a user terminal carried by a passenger and a tagless device of a station, and travel route information is determined by extracting the location information of the passenger according to the movement of a transportation means by receiving base station information of a mobile carrier from the user terminal, thereby enabling accurate intermodal fare settlement based on an actual travel route of a passenger when settling the payment fare per operating agency of public transportation means capable of transfer.

### CROSS-REFERENCE TO RELATED APPLICATION

This application claims priority under 35 U.S.C § 119 to Korean Patent Application No. 10-2024-0082223 filed on Jun. 24, 2024, in the Korean Intellectual Property Office, the entire contents of which are hereby incorporated by reference.

### TECHNICAL FIELD

The present disclosure relates to a tagless payment management apparatus based on linkage of mobile carriers' base stations, and a method and system using the same, and more particularly, to a tagless payment management apparatus based on linkage of mobile carriers' base stations, a method, and a system using the same, in which boarding and alighting are detected in a tagless (contactless) manner by a user terminal carried by a passenger and a tagless device of a station, and travel route information is determined by extracting the location information of the passenger according to the movement of a transportation means by receiving base station information of a mobile carrier from the user terminal, thereby enabling accurate intermodal fare settlement based on an actual travel route of a passenger when settling the payment fare per operating agency of public transportation means capable of transfer.

### BACKGROUND

In large cities, due to severe traffic congestion, most citizens use public transportation means such as subways and buses for commuting. Currently, in most public transportation means, boarding and alighting are performed by utilizing transportation cards embedded with IC chips or smartphones embedded with USIM chips at fare gates, so magnetic tickets have been completely abolished in subways, and cashless buses are being operated in the case of buses. However, since boarding and alighting are still performed by directly touching the transportation card or smartphone, congestion caused by passengers waiting at the ticket gates occurs.

Meanwhile, interest in and development of contactless (untact) technology has been growing recently, and more importantly, the era of one smartphone per person has arrived. Along with the development of short-range wireless communication technology and expansion of infrastructure, tagless systems capable of contactless boarding and alighting at the gates of subways and buses are being developed in order to enable quick boarding and alighting of public transportation means and to alleviate congestion. Some subways and buses have already commercialized the tagless system, and technical demonstrations of the tagless system are being conducted by other urban railway transportation agencies, including Seoul Metro.

The currently commercialized or technically demonstrated tagless systems have a common feature in that they develop a tagless-dedicated application (app) to be installed on smartphones, apply a host card emulation (HCE) method that stores transportation card information in the cloud, and utilize smartphone positioning technology using short-range wireless communication technologies such as beacon, Bluetooth low energy (BLE), or ultra wide band (UWB).

However, the above-described Bluetooth low energy (BLE) has a positioning accuracy of approximately 1 to 3 meters, and due to limitations in radio wave directivity and interference issues, it is difficult to apply to subway ticket gates composed of a plurality of consecutive paths, and is currently implemented only in a single separated path. In addition, the above-described ultra wide band (UWB) has an accuracy of about 10 cm and is therefore expected to be useful, but the functionality is provided only in newer smartphones, and due to the non-disclosure of APIs by the developer, there are limitations in universal application. Furthermore, smartphones equipped with iOS face entry barriers for domestic developers in introducing the tagless system due to policy limitations set by the manufacturer.

In particular, the currently commercialized or technically demonstrated tagless systems are limited to positioning technologies that detect passengers' boarding and alighting by using short-range wireless communication technologies located near the ticket gates in subway stations, and in the case of buses, are also limited to detecting boarding and alighting through passenger positioning.

Meanwhile, in the metropolitan area, urban and metropolitan railways charge fares by calculating the travel distance between the boarding and alighting stations based on passengers directly touching transportation cards or smartphones on the ticket gates. However, since intermodal transportation is possible, where passengers can use lines operated by two or more operating agencies during a single trip, an intermodal fare is being implemented to collect fares for the entire railway section as if it were a single line or operated by a single entity. In particular, since 2014, a metropolitan integrated transfer fare system has been fully implemented in the metropolitan area, which charges fares as if a single transportation means were used without charging a basic fare at each transfer when using public transportation means including both urban/metropolitan railways and metropolitan area buses.

However, as of May 2024, there are 13 operating agencies, 23 lines, and 560 stations operating in the metropolitan urban/metropolitan railway system, and due to this, various travel routes may be provided between one station and another, and even if a single travel route is specified, the involvement of multiple operating agencies is inevitable, resulting in issues in intermodal fare settlement among subway operating agencies.

Currently, intermodal fare settlement undergoes two settlement processes. The first settlement refers to inter-transportation means settlement that occurs when both buses and railways are used together, and it means dividing the total paid fare into bus revenue and railway revenue based on the basic fare ratio, wherein the excess portion beyond the basic railway distance (10 km) is preferentially allocated to the railway. The second settlement refers to the settlement of the railway revenue among actual operating agencies according to a predetermined settlement rule after the first settlement.

In general, the settlement cycle of intermodal fares is conducted once every 3 to 5 years based on relevant laws and agreements, as mutually agreed upon by the operating agencies. However, disagreements over the intermodal fare settlement method among metropolitan railway operating agencies persist, and in reality, the intermodal fare settlements for the years 2015 to 2017 and 2018 to 2021 were finalized only after several years in accordance with the decisions of service agencies or the Metropolitan Transportation Commission.

The current settlement rules utilize the effective vector labeling (EVL) algorithm, which is a methodology that estimates a reasonable route among numerous routes between the boarding station and the alighting station, and a route selection model (Logit Model) that considers variables affecting route choice, such as in-vehicle time, transfer time, and travel cost. However, since the actual travel route of passengers is not transparently reflected, disputes among operating agencies are inevitably ongoing.

In relation to this, Korean Registered Patent No. 10-2541686 (registration date: Jun. 5, 2023, hereinafter referred to as “prior art document”) has been proposed. The prior art document is configured to collect log data generated when a passenger uses public transportation and to trace the travel route of the passenger by linking the log data with video files recorded by cameras installed at stations or stops to photograph the passengers. However, there are limitations in effectiveness due to the inefficiency in continuously collecting and managing a large number of video files recorded at various locations and the complexity of data processing for integrating the log data and the video files.

In addition, other prior art documents such as Korean Registered Patent No. 10-1641997 (registration date: Jul. 18, 2016), Korean Registered Patent No. 10-1429489 (registration date: Aug. 6, 2014), Korean Patent Application Publication No. 10-2007-0052605 (publication date: May 22, 2007), and Korean Patent Application Publication No. 10-2012-0037109 (publication date: Apr. 19, 2012) also disclose technical content related to contactless boarding and alighting and travel route tracking or positioning of buses or subways using GPS or base stations of a mobile carrier. However, there remain limitations in that the passenger still has to manually press the disembarkation button when getting off the bus, the NFC function must be used when transferring at subway ticket gates, GPS positioning applies only to ground-based transportation means, or the server of a mobile carrier must be used.

### PRIOR ART DOCUMENTS

### Patent Documents

(Patent Document 1) Korean Registered Patent No. 10-2541686 (registered on Jun. 5, 2023)
(Patent Document 2) Korean Registered Patent No. 10-1641997 (registered on Jul. 18, 2016)
(Patent Document 3) Korean Patent Application Publication No. 10-2024-0018981 (published on Feb. 14, 2024)
(Patent Document 4) Korean Registered Patent No. 10-0322257 (registered on Jan. 14, 2002)
(Patent Document 5) Korean Registered Patent No. 10-1429489 (registered on Aug. 6, 2014)
(Patent Document 6) Korean Patent Application Publication No. 10-2007-0052605 (published on May 22, 2007)
(Patent Document 7) Korean Patent Application Publication No. 10-2012-0037109 (published on Apr. 19, 2012)

### SUMMARY

The present disclosure has been devised to solve the problems of the above-described prior art, and an object thereof is to provide a tagless payment management apparatus based on linkage of mobile carriers' base stations, and a method and system using the same, which not only detects boarding and alighting of passengers in a tagless manner by utilizing short-range wireless communication technology, but also enables accurate fare settlement among different operating agencies by reflecting the actual travel route of passengers, allows tracking of the actual travel route of the passenger by using an optimized computation model that estimates the expected travel route even without installing additional infrastructure, and enables quick settlement and distribution by automatically processing fare settlement based on the determined travel route, thereby preventing the occurrence of unallocated balances, and omits gates such as flaps that obstruct the flow of passenger traffic.

In order to achieve the above object, a tagless payment method M based on linkage of mobile carriers' base stations according to the present disclosure is provided for public transportation means that allow transfers, by a payment management apparatus PS including a communication module for transmitting and receiving information with a user terminal 10; a memory storing an application for providing the tagless payment method based on linkage of mobile carriers' base stations; and a processor executing the application stored in the memory, the method comprising: receiving boarding information (S10) in which the processor, by executing the application, receives boarding information from the user terminal 10 when boarding is detected through communication between a short-range communication module of the passenger's user terminal 10 and a short-range communication module of a tagless device 20 installed at a station; extracting location information (S20) in which the processor receives information of a connected mobile network operator base station from the user terminal 10 at preset time intervals, extracts location information of the passenger according to the movement of a transportation means, and matches the location information with the boarding information received from the user terminal 10; receiving alighting information (S30) in which the processor receives alighting information from the user terminal 10 when alighting is detected through communication between the short-range communication module of the passenger's user terminal 10 and the short-range communication module of the tagless device 20 installed at a station; settling fare (S40) in which the processor settles fare information based on a route-specific fare database by using the boarding and alighting information and the location information; and managing information (S50) in which the processor transmits the boarding and alighting information, the location information, and the settled fare information to a main server 30.

In addition, the location information extracting step (S20) may include: a base station information receiving step (S21) in which the processor receives information of a mobile carrier's base station to which the user terminal 10 is connected in real time; and a location information converting step (S22) in which the processor converts the received base station information into location information based on a base station database.

In addition, the alighting information receiving step (S30) may further include a travel route determining step (S35) of determining a travel route of the passenger as one of a plurality of expected travel routes based on a route map of the transportation means using the extracted location information, considering the possibility of transfer.

In addition, the travel route determining step (S35) may estimate expected travel routes by sequentially tracking the chronologically extracted location information, and when one of the estimated expected travel routes is specified, the finally specified expected travel route may be determined as the travel route.

In addition, the fare settlement step (S40) may include a fare determining step (S41) of determining a payment fare of the passenger based on a fare DB per route using the boarding and alighting information and the location information; and an intermodal fare determining step (S42) of settling intermodal fares for each operating agency of the transportation means with respect to the payment fare.

In addition, the intermodal fare determining step (S42) may process a first settlement, which is a preliminary settlement according to prescribed settlement criteria with respect to the payment fare of the passenger, and process a second settlement, which settles the remaining fare after the first settlement based on the distance ratio per route managed by each operating agency according to the location information.

Meanwhile, the payment management apparatus PS of the present disclosure includes a communication module for transmitting and receiving information with a user terminal 10, a memory in which an application for providing a tagless payment method based on linkage of mobile carriers' base stations is stored, and a processor that executes the application stored in the memory. The processor, by executing the application, receives boarding information from the user terminal 10 when boarding is detected as a short-range communication module of the user terminal 10 of a passenger communicates with a short-range communication module of a tagless device 20 installed in a station; receives information of mobile carriers' base station to which the user terminal 10 is connected, extracts location information of the passenger according to the movement of the transportation means, and matches the received boarding information from the user terminal 10; receives alighting information from the user terminal 10 when alighting is detected as the short-range communication module of the user terminal 10 of the passenger communicates with the short-range communication module of the tagless device 20 installed in the station; settles fare information based on a fare database per route using the boarding and alighting information and the location information; and transmits the boarding and alighting information, the location information, and the settled fare information to a main server 30.

Furthermore, a tagless payment system S based on linkage of mobile carriers' base stations according to the present disclosure is provided for public transportation means capable of transfer, and includes: a user terminal 10 that is equipped with a short-range communication module for detecting boarding and alighting of a passenger and performs wireless mobile communication with a mobile carriers' base station; a tagless device 20 that is installed in each station, equipped with a short-range communication module to communicate with the user terminal 10 carried by the passenger to detect boarding and alighting of the passenger, and transmits the boarding and alighting information of the passenger to a main server 30; a payment management apparatus PS, wherein a processor, by executing an application stored in a memory, receives information of mobile carriers' base station to which the user terminal 10 carried by the passenger is connected, extracts location information of the passenger according to the movement of the transportation means, matches the received boarding and alighting information from the user terminal 10, settles fare information based on a fare database per route using the boarding and alighting information and the location information, and transmits the boarding and alighting information, the location information, and the settled fare information to the main server 30; and the main server 30 that receives and stores the boarding and alighting information, the location information, and the settled fare information from the payment management apparatus PS.

And the tagless device 20 may include an always-open gate 21 installed within the station to avoid obstructing passenger flow; a plurality of short-range communication anchors 22 for positioning passenger locations within the station; a tagless terminal 23 equipped with a short-range communication module installed on the always-open gate 21 to detect passenger boarding and alighting; and a positioning processor 24 configured to receive passenger location data detected via the short-range communication anchors 22 and passenger boarding and alighting data detected via the tagless terminal 23, and to transmit the data to the payment terminal 26 and the passenger's user terminal 10.

According to the tagless payment management apparatus based on linkage of mobile carriers' base stations of the present disclosure, along with the method and system using the same, boarding and alighting in a tagless manner may be implemented by detecting boarding and alighting through mutual communication between a short-range communication module installed in a user terminal carried by a passenger and a short-range communication module provided in a tagless device installed in a station. This enables the realization of a continuous flow of passengers, thereby minimizing congestion even during commuting hours.

In particular, the payment management apparatus of the present disclosure receives information from mobile carriers' base stations, and extracts the passenger's location information corresponding to the movement of the transportation means. By matching this with boarding and alighting information received from the user terminal, it is possible to reflect the actual travel path of the passenger. This enables accurate fare settlement among multiple operating agencies without disputes.

Furthermore, since mobile carriers' base stations are installed even in underground tunnels and deep-level tunnels where communication is challenging, real-time changes in passenger location information may be easily determined using the user terminal without the need for additional communication infrastructure.

In addition, the payment management apparatus may determine a passenger's travel route by selecting one among multiple expected travel routes that are possible due to transfers, based on the transportation route map using the extracted location information, and by sequentially tracking the chronologically extracted location information, if the estimated multiple expected travel routes are specified as one, it may determine this as the actual travel route using a computation model, thereby achieving efficiency and optimization in the computation for determining the travel route.

Moreover, the payment management apparatus automatically processes fare settlement according to the settlement model based on the route-specific fare database using the boarding and alighting information and travel route information, thereby enabling rapid settlement and distribution, and thus allowing operating agencies to pursue management efficiency by resolving accounting disadvantages such as the occurrence of unallocated balances due to delayed settlement.

### BRIEF DESCRIPTION OF THE DRAWINGS

FIG. 1 is a configuration diagram illustrating an overall network-centric view of a tagless payment system based on linkage of mobile carriers' base stations according to an embodiment of the present disclosure.

FIG. 2 is a user interface of an application installed on a user terminal according to an embodiment of the present disclosure.

FIG. 3 is a conceptual diagram illustrating, in chronological order, the interaction between a passenger's movement and the tagless payment system based on linkage of mobile carriers' base stations according to an embodiment of the present disclosure.

FIG. 4 is a configuration diagram illustrating an overall location-centric view of a tagless payment system based on linkage of mobile carriers' base stations according to an embodiment of the present disclosure.

FIGS. 5A and 5B are configuration diagrams illustrating in more detail the flow of information processed in boarding and alighting stations and transfer stations constituting FIG. 4.

FIG. 6 is a block diagram illustrating, in chronological order, a tagless payment method based on linkage of mobile carriers' base stations provided by a payment management apparatus according to an embodiment of the present disclosure.

FIG. 7 is a perspective view illustrating an open gate according to an embodiment of the present disclosure.

FIG. 8 is a block diagram illustrating the overall configuration of a tagless device according to an embodiment of the present disclosure.

FIGS. 9A and 9B are conceptual diagrams sequentially illustrating the boarding, alighting, and payment processes of a tagless device according to an embodiment of the present disclosure.

FIG. 10 is a flowchart illustrating, in chronological order, a computation model of a travel route determination step of the present disclosure.

FIG. 11 is a transportation route map for explaining the travel route determination step according to an embodiment of the present disclosure.

FIG. 12 is a flowchart illustrating, in chronological order, a settlement model of a fare settlement step of the present disclosure.

### DETAILED DESCRIPTION OF THE PREFERRED EMBODIMENTS

Hereinafter, a preferred embodiment of the present disclosure will be described in detail based on the matters illustrated in the drawings. However, detailed descriptions of related known functions or configurations will be omitted when it is determined that such descriptions may unnecessarily obscure the gist of the present disclosure.

The present disclosure relates to a tagless payment management apparatus PS based on linkage of mobile carriers' base stations, and a method M and system S using the same. A tagless device 20, provided in a station of a public transportation means such as a subway (defined to include urban and metropolitan railways) or a bus (defined to include a platform or the interior of the bus), detects boarding and alighting in a tagless manner through communication with a user terminal 10 carried by a passenger. The payment management apparatus PS receives mobile carriers' base station information and boarding/alighting information from the user terminal 10, matches them, extracts location information of the passenger according to the movement of the transportation means, and determines travel route information, thereby performing accurate fare settlement reflecting the actual travel route of the passenger.

The user terminal 10, the payment management apparatus PS, and the main server 30 are all computing devices comprising a memory, a processor, and a communication module. The memory stores respective applications, the processor executes the applications, and the communication module enables mutual information exchange using a communication network. Additionally, the payment management apparatus PS and the main server 30 may be implemented such that services are provided through multiple programs within a single server. Alternatively, servers composed of multiple hardware components may be configured as independent distributed servers that exchange information with each other.

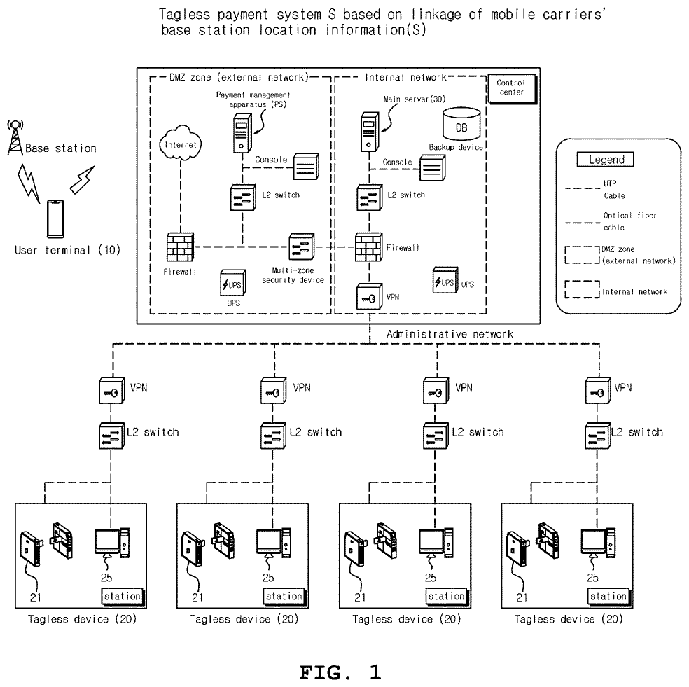

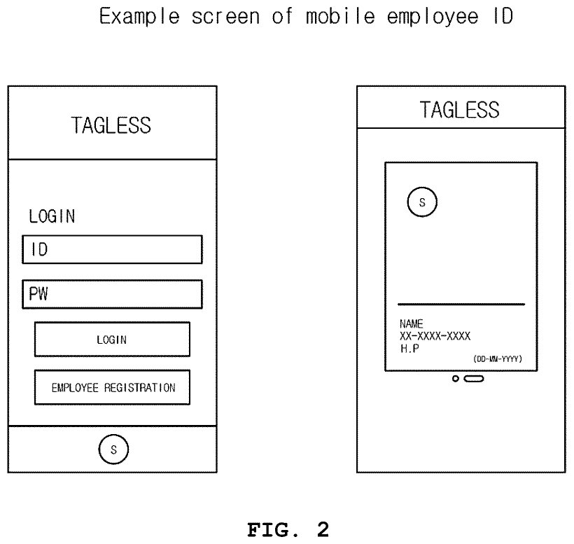

FIG. 1 illustrates the overall configuration of the tagless payment system S based on linkage of mobile carriers' base stations according to an embodiment of the present disclosure, centered around the network. As shown in FIG. 2, the payment management apparatus PS is connected to a public network to transmit and receive information in response to a request from a user terminal 10 on which an application is installed, and is implemented in the form of an app server to maintain the application. Furthermore, the payment management apparatus PS transmits the processed information to the main server 30, which is managed within a control center by the operating agency of the tagless payment system through a private network for security purposes, and stores it. At this time, it is preferable to connect an additional backup device to the main server 30 to backup and store the processed information.

Meanwhile, the tagless device 20 defined in the present disclosure is implemented in the form of a system comprising multiple devices installed in each station, and is configured to include a gate 21, which is located within the station and manages boarding and alighting by performing short-range wireless communication with a user terminal 10 carried by a passenger, and a station computer 25, which collects and processes boarding, alighting, and payment information and transmits it to the main server 30. In this case, the station computer 25 is a computing device having a processor, a memory, and a communication module, and is connected to a public network due to the physical distance from the main server 30.

As illustrated in FIG. 1, the payment management apparatus PS may also be installed within a control center, and is connected to the private network of the main server 30 via an internal firewall, while data transmitted from the user terminal 10 is installed in a DMZ zone so that it is received through a gateway and an external firewall. Data transmitted from the payment management apparatus PS is delivered to the private network through a multi-zone security device, which is a unidirectional transmission device. Furthermore, the station computer 25 of the tagless device 20 and the main server 30 are implemented as a virtual private network (VPN) that establishes tunneling for security up to the firewall of the private network.

Hereinafter, with reference to FIGS. 1 to 5B, the user terminal 10, the tagless device 20, the payment management apparatus PS, and the main server 30, which constitute the tagless payment system based on linkage of mobile carriers' base stations according to an embodiment of the present disclosure, will be described in more detail.

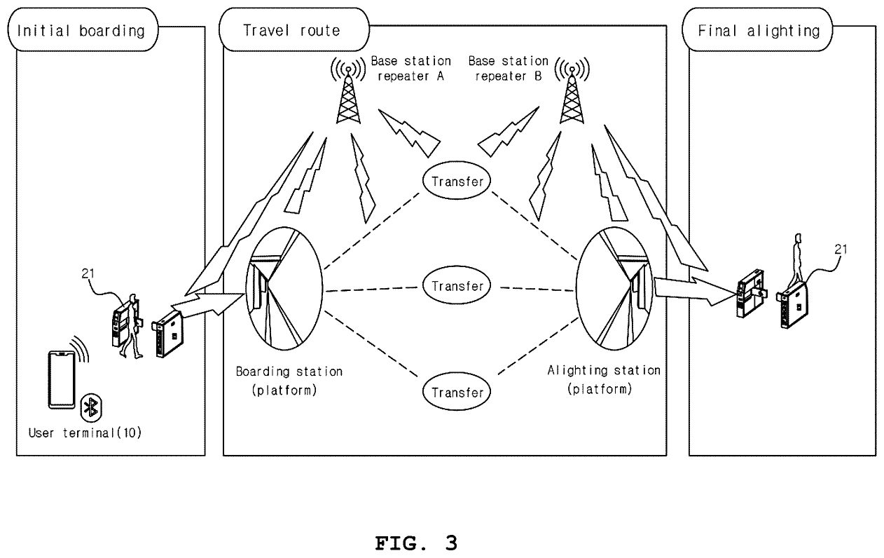

FIG. 3 is a conceptual diagram illustrating, in chronological order, the interaction between the tagless payment system based on linkage of mobile carriers' base stations and the movement of a passenger according to an embodiment of the present disclosure. The interaction may be examined by dividing it into the station where the passenger boards and alights, the stations where the passenger passes through and transfers according to movement, and the control center.

Meanwhile, the user terminal 10 is carried individually by each passenger and moves through the station regardless of location. In this case, the user terminal 10 is a computing device equipped with a short-range communication module for detecting boarding and alighting of the passenger, capable of wireless mobile communication with a mobile carriers' base stations, and capable of installing and executing an application supporting the tagless payment method of the present disclosure. Such computing devices may include smartphones, tablets, smartwatches, wearable terminals, and other mobile communication terminals.

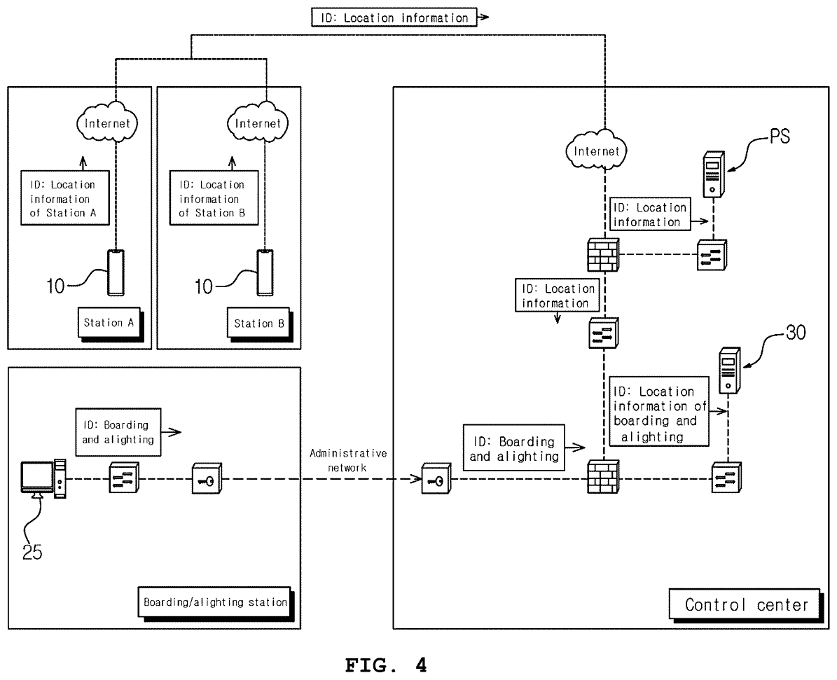

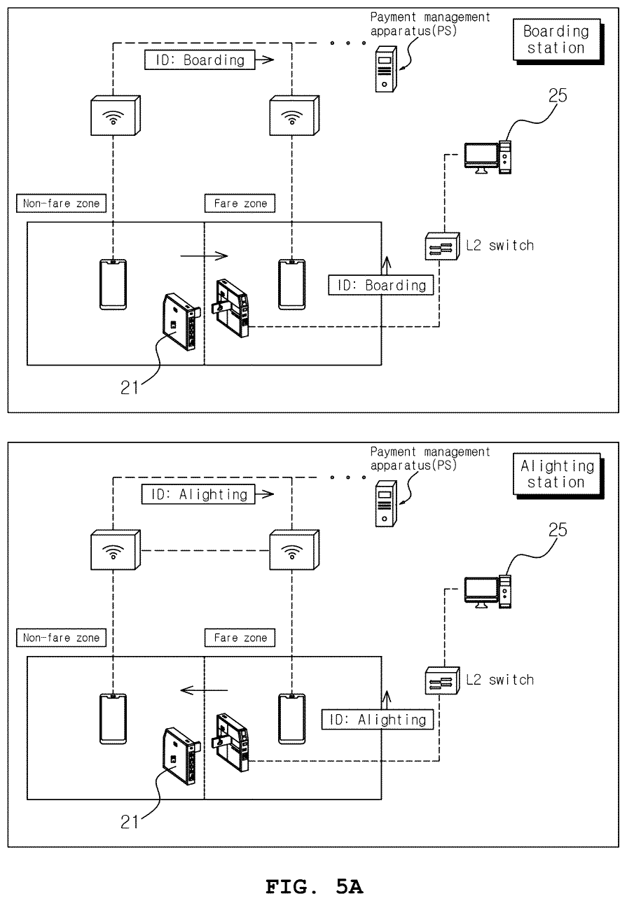

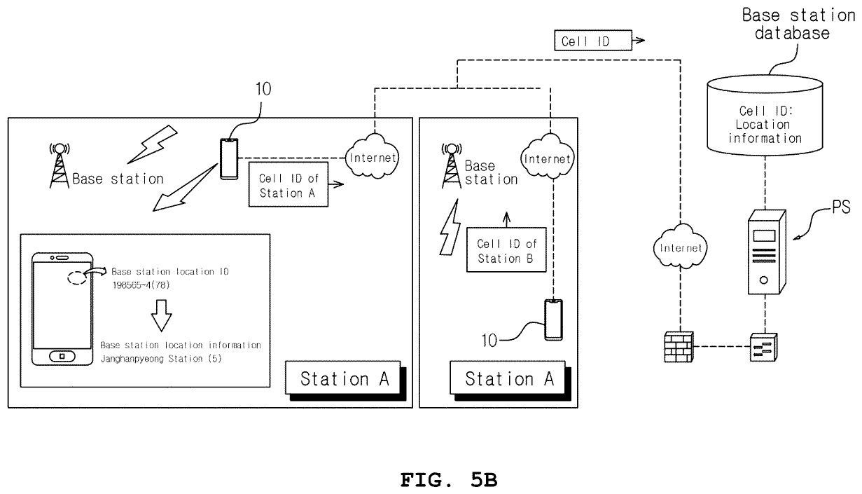

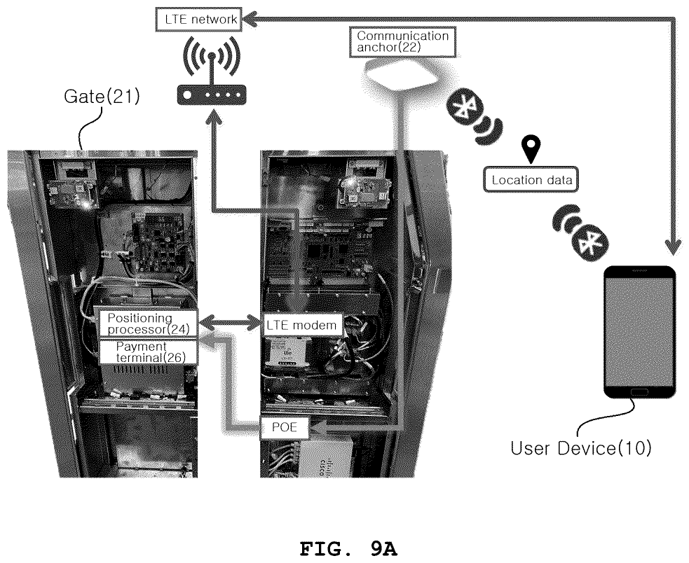

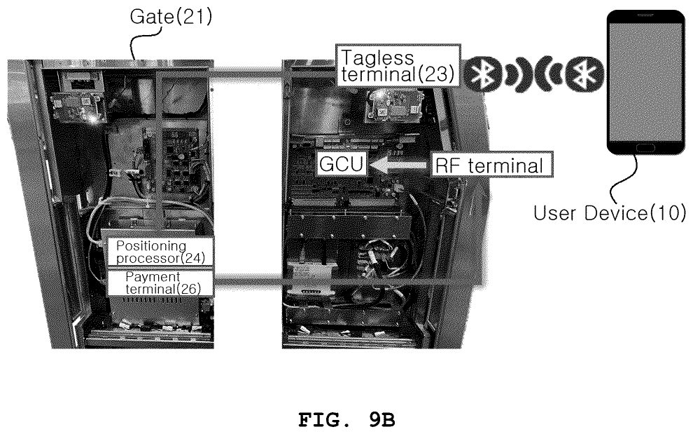

As illustrated in FIGS. 4 and 5A, in the station where the passenger boards and alights, the passenger carries the user terminal 10 and passes through the gate 21 of the tagless device 20 installed in each station. As the passenger passes through, the short-range communication modules of the user terminal 10 and the tagless device 20 communicate with each other, thereby detecting the boarding and alighting. It is preferable that the short-range communication module utilizes Bluetooth low energy (BLE), ultra-wideband communication (UWB), or a combination thereof. In one embodiment, as illustrated in FIG. 9A, the short-range communication anchor 22 performs short-range communication with the user terminal 10 to identify passenger location data and may request the user terminal 10 to activate the application via a mobile communication network to prepare for gate passage. At this time, passenger location data may also be received from a base station installed in the station. Subsequently, the tagless terminal 23 embedded in the gate 21 performs short-range communication with the user terminal 10 to acquire detected boarding and alighting data of the passenger, thereby accurately identifying whether the passenger has boarded or alighted.

In this case, the gate 21 may be an open gate without a flap and functions as a boundary device that physically separates the non-fare zone and the fare zone. Therefore, if the passenger's location information or boarding and alighting data may be accurately identified through the short-range communication anchor 22 or the tagless terminal 23, either the communication anchor 22 or the tagless terminal 23 may be implemented alone, or the gate 21 itself may be omitted. In one embodiment, in the case of a bus, due to the limited space inside the bus, a beacon utilizing Bluetooth low energy (BLE) as a short-range communication module may be used as the tagless terminal 23 near the entrance.

That is, when boarding is detected as the passenger moves from the non-fare zone to the fare zone, or when alighting is detected as the passenger moves from the fare zone to the non-fare zone, the boarding and alighting information, along with the user ID of the user terminal 10, is transmitted to the station computer 25. The processor of the station computer 25 collects the boarding and alighting information and payment information, and transmits them to the main server 30.

However, in the present disclosure, a separate short-range communication anchor 22 may be omitted, and the short-range communication module provided in the tagless terminal 23 is defined to include Bluetooth low energy (BLE), ultra-wideband communication (UWB), as well as NFC technology, which is currently widely used. Therefore, even in cases where the method is not tagless, contrary to the title of the invention, if the problem-solving principle addressed by the present disclosure is common, it may still fall within the scope of protection of the present disclosure.

As illustrated in FIGS. 4 and 5B, as the passenger moves by boarding the transportation means, mobile carriers' base stations are installed at regular intervals along the travel route on the platforms and tracks of the stations that are passed through. In the case of subways, on average, approximately seven base stations are installed in a single station, including concourses, platforms, and terminals. As the user terminal 10 carried by the passenger moves, the mobile carriers' base stations connected for wireless mobile communication changes in real time, and each mobile carriers' base station has a unique Cell ID. Therefore, the payment management apparatus PS receives mobile carriers' base station information, including the connected Cell ID, from the user terminal 10 at predetermined time intervals in real time. Subsequently, the payment management apparatus PS extracts the passenger's location information according to the movement of the transportation means using the received mobile carriers' base station information.

As illustrated in FIG. 4, the control center managed by the operating agency of the tagless payment system houses the main server 30 and the payment management apparatus PS. In the process of the payment management apparatus PS receiving mobile carriers' base station information from the user terminal 10 and extracting location information, the payment management apparatus PS may convert the Cell ID of the received mobile carriers' base station information into real-time location information based on a base station database constructed with location information on stations or tracks corresponding to the Cell ID of the mobile carriers' base stations.

Furthermore, the payment management apparatus PS may integrate boarding and alighting information and location information for a specific passenger by matching the user ID of the boarding information received from the user terminal 10 with the user ID of the user terminal 10 that transmitted the mobile carriers' base stations information. The payment management apparatus PS settles the fare information calculated based on the route-specific fare database using the integrated boarding and alighting information and location information for each passenger's user ID. At this time, the fare information is defined to include the payment fare to be paid by the passenger and the intermodal fare settled by each operating agency.

Subsequently, the payment management apparatus PS transmits the boarding and alighting information, location information, and fare information to the main server 30, and also transmits the location information and payment fare information to the user terminal 10. As described above, an external firewall and an internal firewall exist between the payment management apparatus PS and the main server 30, and additionally, a multi-zone security device is provided therebetween to encrypt sensitive information, which may be transmitted to the main server 30 through a private communication network.

Meanwhile, the main server 30 may receive the boarding and alighting information, and the payment fare information among the fare information, not only from the payment management apparatus PS but also from the tagless device 20 of the station where the passenger boarded or alighted, therefore, when storing the information in a database, it is possible to correct any lost or erroneous information.

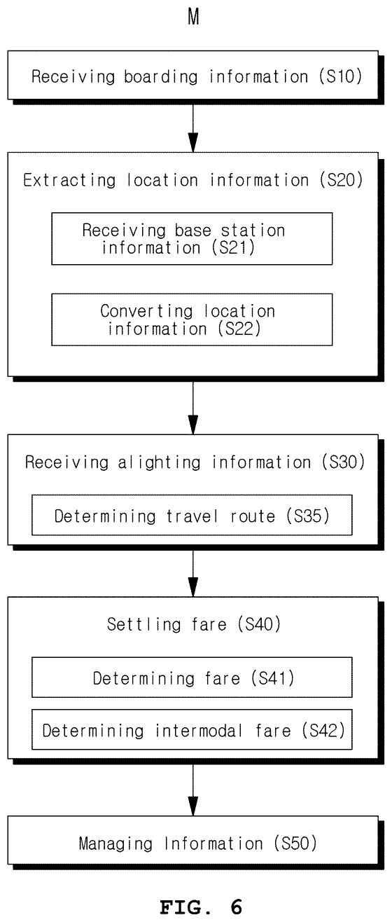

FIG. 6 is a conceptual and block diagram illustrating, in chronological order, the tagless payment method M based on linkage of mobile carriers' base stations provided by the payment management apparatus PS according to an embodiment of the present invention. It targets public transportation, including subways managed by multiple operating agencies. During the process in which a specific passenger boards at a certain station, uses public transportation to move, and alights at another station, the steps performed by the payment management apparatus PS may be described in chronological order as follows: a boarding information receiving step (S10), a location information extracting step (S20), an alighting information receiving step (S30), a fare settlement step (S40), and an information management step (S50).

First, the boarding information receiving step (S10) is a step of receiving boarding information from the user terminal 10 when boarding is detected through communication between the short-range communication module of the user terminal 10 carried by the passenger and the short-range communication module of the tagless device 20 installed in the station.

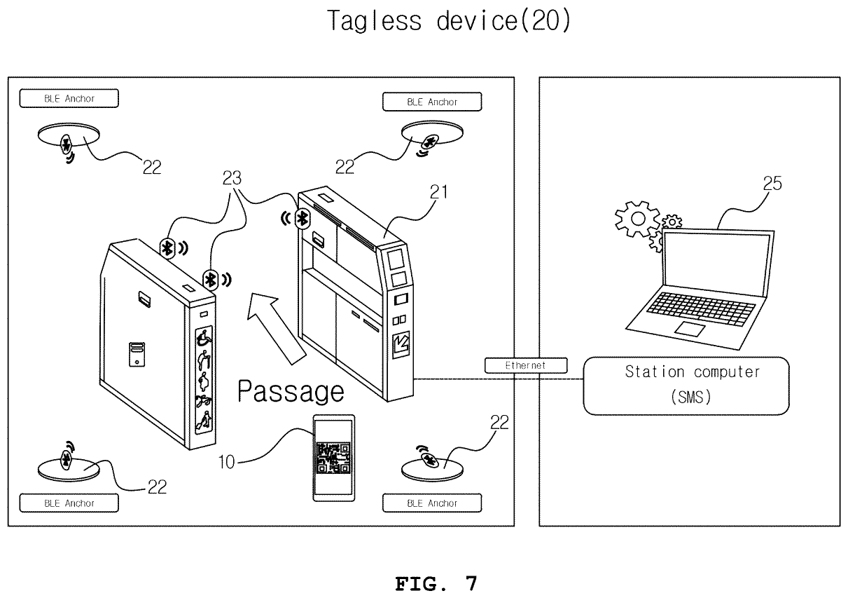

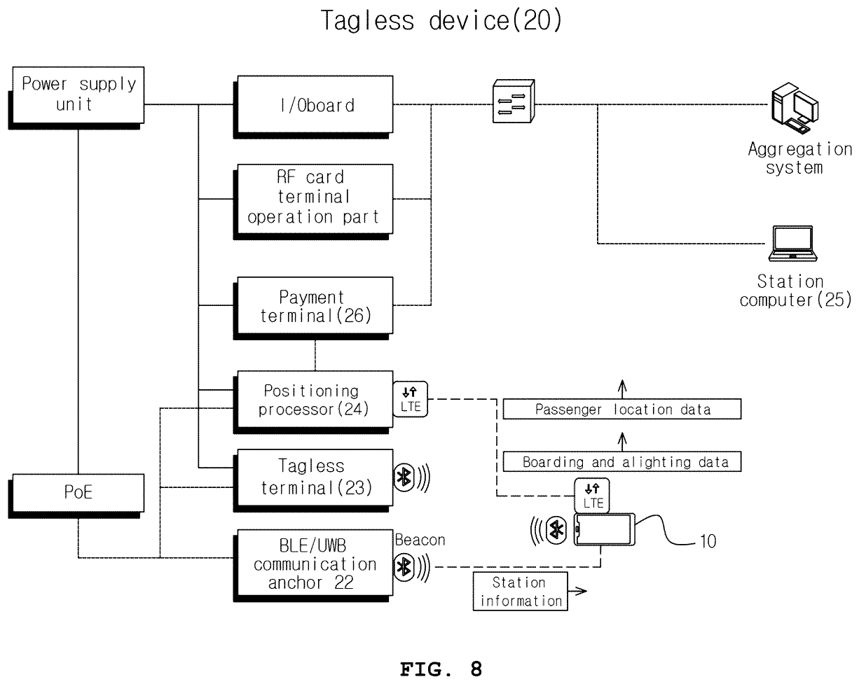

More specifically, as illustrated in FIGS. 7 and 8, when the passenger moves from the non-fare zone to the fare zone, which are separated by the gate 21, the passenger location data measured by a plurality of short-range communication anchors 22 spaced apart within the station, and the boarding data of the passenger measured by the tagless terminal 23 provided in the open gate 21 are detected. Then, the positioning processor 24 determines whether boarding has occurred based on the passenger location data and the boarding data, and transmits the boarding information to the station computer 25 and the user terminal 10. The positioning processor 24 is also a computing device including a processor, memory, and a communication module. Subsequently, the processor of the station computer 25 collects the received boarding information and transmits it to the main server 30.

At this time, as illustrated in FIG. 9B, if the main server 30 determines that the boarding is normal, it may approve the passage through the gate 21 via the gate control unit (GCU). If it determines that the boarding is abnormal, it may transmit a notification regarding the abnormal boarding to the user terminal 10 or the gate 21. This also applies to the alighting information receiving step (S30).

The location information extracting step (S20) includes receiving, at predetermined time intervals, information on the mobile carriers' base station to which the user terminal 10 is connected, extracting the passenger's location information based on the movement of the transportation means, and matching this information with the boarding information received from the user terminal 10. This step may be subdivided into a base station information receiving step (S21), in which the information on the mobile carriers' base station to which the user terminal 10 is connected in real-time is received, and a location information converting step (S22), in which the received mobile carriers' base station information is converted into location information based on a base station database.

As described above, in the location information converting step (S22), the payment management apparatus PS converts the Cell ID of the received mobile carriers' base station information into real-time location information based on a base station database that includes location information of stations or tracks corresponding to the Cell IDs of mobile carriers' base stations. The payment management apparatus PS matches the user ID of the boarding information received from the user terminal 10 with the user ID of the user terminal 10 that transmitted the mobile carriers' base station information, integrates the boarding information and location information for a specific passenger, and records and stores this information in a user table.

Meanwhile, in the case of domestic buses, the National public transportation information center, linked to the Bus information system (BIS) server, provides a service that offers real-time bus location information by integrating GPS and GIS information through an Open API. Therefore, in another embodiment, for transportation means where location information services are provided, the location information extracting step (S20) may include receiving, at predetermined time intervals, the passenger's location information based on the movement of the transportation means from the BIS server, in parallel with the passenger's location information obtained through the mobile carriers' base station to which the user terminal 10 is connected.

In other words, even when the types of transportation means differ, such as buses and subways, or when the operating agencies are different, transfers are possible, and if the transfer is made within a certain period of time, an intermodal fare may be applied according to the intermodal transportation; therefore, when intermodal transportation occurs, the location information of the passenger continues to be recorded and stored in the user table of the payment management apparatus PS even after the transfer, for fare settlement.

The alighting information receiving step (S30) comprises detecting alighting through communication between the short-range communication module of the passenger's user terminal 10 and the short-range communication module of the tagless device 20 installed in the station, and receiving alighting information from the user terminal 10 upon such detection.

Similar to the boarding information receiving step (S10), in the alighting information receiving step (S30), as illustrated in FIGS. 7 and 8, when a passenger moves from the fare zone to the non-fare zone, distinguished based on the gate 21, the passenger's location data is measured by multiple short-range communication anchors 22, and alighting data is detected by the tagless terminal 23. Subsequently, the processor of the positioning processor 24 determines the alighting status based on the passenger's location data and alighting data. The boarding and alighting information is then transmitted to the user terminal 10 and also to the main server 30 via the station computer 25.

Additionally, as illustrated in FIG. 9B, the positioning processor 24 integrates the boarding and alighting information and transmits it to the payment terminal 26, thereby processing the passenger's fare payment. That is, the fare settlement step (S40), which will be described later, is performed in near real-time, such that no temporal difference is perceived from the alighting information receiving step (S30). The fare information is transmitted to the user terminal 10 and, via the station computer 25, to the main server 30.

Subsequently, the main server 30, upon determining that the fare has been successfully processed, deems the alighting to be normal and authorizes passage through the gate 21 via the gate control unit (GCU). If the alighting is determined to be abnormal, a notification regarding the abnormal alighting may be transmitted to the user terminal 10 or the gate 21.

Meanwhile, the alighting information receiving step (S30) may further include a travel route determination step (S35), in which the payment management apparatus PS utilizes the location information extracted in the location information extracting step (S20) and, based on the transportation route map, determines the passenger's travel route information by selecting one of multiple possible travel routes resulting from the possibility of transfers.

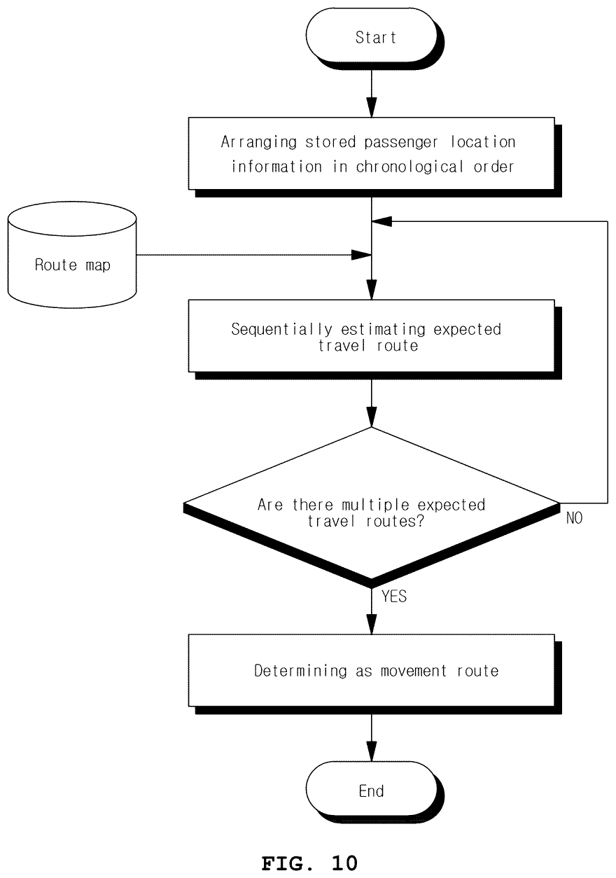

In one embodiment, as illustrated in FIG. 10, the payment management apparatus PS employs a computation model for determining the travel route in the travel route determination step (S35). This computation model sequentially tracks the chronologically extracted location information to estimate the expected travel route. When one of the multiple estimated expected travel routes is specified, the finally specified expected travel route is determined as the travel route.

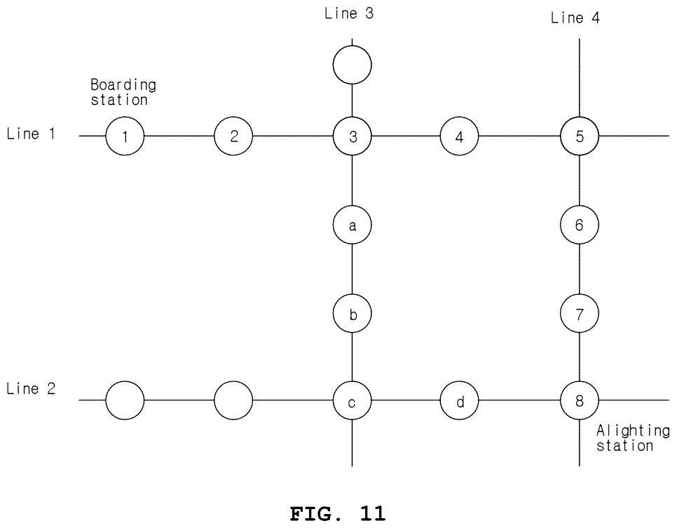

FIG. 11 is a transportation route map conceptually illustrating the travel route determination step (S35). In the location information extracting step (S20), if the ideal time for the transportation means to travel between each station is 2 minutes, and the time interval set to receive mobile carriers' base station information is also 2 minutes, the payment management apparatus PS sequentially extracts the passenger's location information in the order of station (1), station (2), and station (3).

Subsequently, in the alighting information receiving step (S30), if the initial boarding is determined to have occurred at station (1) and the final alighting at station (8), the passenger's travel route may be predicted as one of multiple expected travel routes, such as (1)-(2)-(3)-(4)-(5)-(6)-(7)-(8) or (1)-(2)-(3)-(a)-(b)-(c)-(d)-(8), considering the possibility of transfers. In this case, the computation model of the payment management apparatus PS sequentially tracks the location information, extracting the location information in chronological order starting from station (1). Upon extracting the location information of station (4), it immediately ceases computation based on the transportation route map and determines the travel route as (1)-(2)-(3)-(4)-(5)-(6)-(7)-(8) among multiple expected travel routes.

Furthermore, even if communication between the user terminal 10 and the mobile carriers' base station is poor, or if poor communication occurs due to the storage location or condition of the user terminal 10, resulting in the failure to receive station information for certain sections, or even if the communication time interval of the user terminal 10 for receiving base station information is extended, if any one of the station information among stations (a), (b), (c), (d) or among stations (4), (5), (6), (7) is received, the computation model of the payment management apparatus PS may automatically determine the travel route based on the transportation route map, providing a technical advantage. Additionally, since it is sufficient to communicate at predetermined time intervals without continuously consuming communication power to receive base station location information, a technical effect of improving power consumption may also be expected.

Meanwhile, in the travel route determination step (S35), the location information used by the computation model for determining the travel route may include not only the passenger's location information received from the mobile carriers' base station but also the passenger's location information provided by the BIS server operated by the National public transportation information center, as the passenger transfers to another transportation means such as a bus.

Next, the fare settlement step (S40) is a step in which fare information is settled based on the route-specific fare database using the boarding and alighting information and location information, and includes a fare determination step (S41) and an intermodal fare determination step (S42). In the route-specific fare database, the fares that passengers must pay for boarding and alighting stations are organized, and the payment management apparatus PS determines the passenger's fare using the boarding and alighting information and travel route information based on the route-specific fare database (S41). Subsequently, the payment management apparatus PS settles the determined payment fare as an intermodal fare for each operating agency of the transportation means (S42).

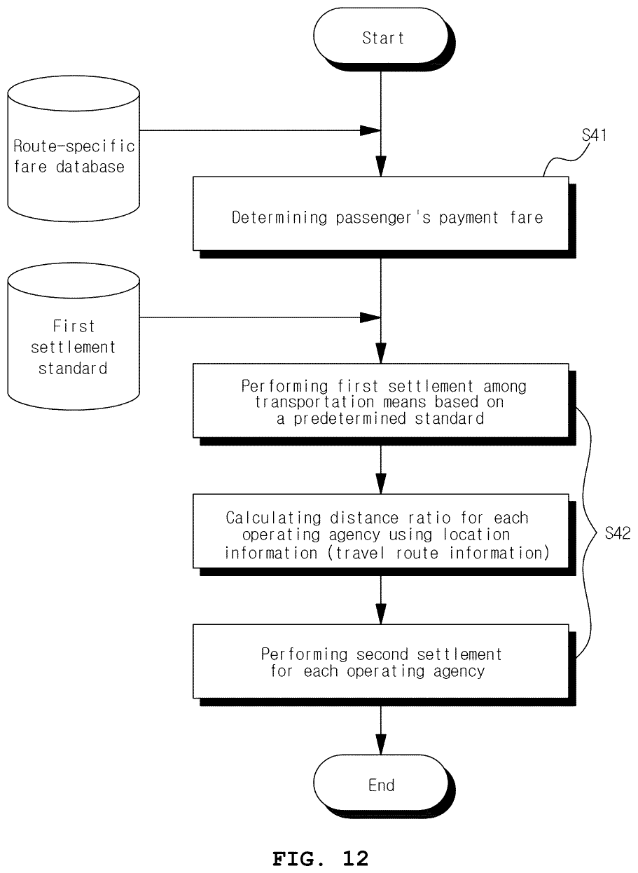

More specifically, in the intermodal fare determination step (S42), the payment management apparatus PS utilizes a settlement model for fare settlement, as illustrated in FIG. 12. The settlement model automatically processes a first settlement, which is a pre-settlement between different transportation means, such as railways and buses, according to prescribed settlement criteria for the passenger's payment fare. For the remaining fare after the first settlement, the model automatically processes a second settlement based on the route-specific distance ratio on the travel route managed by each operating agency, according to the location information.

Thereafter, the information management step (S50) is a step in which the payment management apparatus PS transmits and stores the boarding and alighting information, travel route information, and settled fare information to the main server 30. At this time, the payment management apparatus PS may also transmit payment fare information and travel route information to the user terminal 10.

The tagless payment management apparatus PS based on linkage of mobile carriers' base stations, the method M, and the system S using the same according to the present invention described above may be implemented in various specific forms without altering the technical spirit or essential characteristics of the present invention by those skilled in the art to which the present invention pertains. In particular, unlike the title of the invention or the preamble of the claims, even in cases where the method is not a tagless method, if the principle of solving the problem intended to be solved by the present disclosure is common, it can still be regarded as falling within the scope of protection of the present disclosure.

Therefore, the embodiments described above are illustrative in all aspects and should not be construed as limiting, and the scope of the present invention is indicated by the claims described below rather than the foregoing detailed description. All modifications or variations derived from the meaning, scope, and equivalent concepts of the claims should be interpreted as being included within the scope of the present invention.

### DESCRIPTION OF REFERENCE NUMERALS

S: tagless payment system
PS: payment management apparatus
10: user terminal 20: tagless device
21: open gate 22: short-range communication anchor
23: tagless terminal 24: positioning processor
25: station computer 26: payment terminal
30: main server

What is claimed is:

1. A tagless payment method M based on linkage of mobile carriers' base stations, provided for public transportation means that allow transfers, by a payment management apparatus (PS) including: a communication module for transmitting and receiving information with a user terminal (10); a memory storing an application for providing the tagless payment method based on linkage of mobile carriers' base stations; and a processor executing the application stored in the memory, the method comprising:
receiving boarding information (S10) in which the processor, by executing the application, receives boarding information from the user terminal (10) when boarding is detected through communication between a short-range communication module of the user terminal (10) of a passenger and a short-range communication module of a tagless device (20) installed at a station;
extracting location information (S20) in which the processor receives information of a connected mobile carriers' base stations from the user terminal (10) at preset time intervals, extracts location information of the passenger according to the movement of a transportation means, and matches the location information with the boarding information received from the user terminal (10);
receiving alighting information (S30) in which the processor receives alighting information from the user terminal (10) when alighting is detected through communication between the short-range communication module of the user terminal (10) of the passenger and the short-range communication module of the tagless device (20) installed at a station;
settling fare (S40) in which the processor settles fare information based on a route-specific fare database by using the boarding and alighting information and the location information; and
managing information (S50) in which the processor transmits the boarding and alighting information, the location information, and the settled fare information to a main server (30).

2. The tagless payment method based on linkage of mobile carriers' base stations according to claim 1,
wherein the extracting location information (S20) comprises:
receiving base station information (S21) in which information of a mobile carriers' base station to which the user terminal (10) is connected in real time is received; and
converting location information (S22) in which the received mobile carrier's base station information is converted into location information based on a base station database.

3. The tagless payment method based on linkage of mobile carriers' base stations according to claim 2,
wherein the receiving alighting information (S30) comprising:
determining a travel route (S35) in which a travel route of the passenger is determined as one of a plurality of estimated travel routes based on a route map of the transportation means and using the extracted location information, under the condition that transfers are available.

4. The tagless payment method based on linkage of mobile carriers' base stations according to claim 3,
wherein the determining a travel route (S35) comprises:
estimating an estimated travel route by sequentially tracking the extracted location information in chronological order; and
when a plurality of the estimated expected travel routes are specified as one, determining the finally specified expected travel route as the travel route.

5. The tagless payment method based on linkage of mobile carriers' base stations according to claim 1,
wherein the settling fare (S40) comprises:
determining a payment fare (S41) in which a payment fare of the passenger is determined based on a route-specific fare database using the boarding and alighting information and the location information; and
determining an intermodal fare (S42) in which an intermodal fare is settled for each operating agency of the transportation means based on the determined payment fare.

6. The tagless payment method based on linkage of mobile carriers' base stations according to claim 5,
wherein the determining an intermodal fare (S42) comprises:
performing a first settlement as a preliminary settlement according to a predetermined settlement standard with respect to the payment fare of the passenger; and
performing a second settlement for a remaining fare after the first settlement based on a distance ratio by route managed by each operating agency, using the location information.

7. A tagless payment management apparatus PS based on linkage of mobile carriers' base stations, comprising:
a communication module for transmitting and receiving information with a user terminal (10);
a memory storing an application for providing a tagless payment method based on linkage of mobile carriers' base stations; and
a processor executing the application stored in the memory,
wherein the processor, by executing the application:
receives boarding information from the user terminal (10) when boarding is detected through communication between a short-range communication module of the passengers' user terminal (10) and a short-range communication module of a tagless device (20) installed at a station;
receives information of a mobile carrier's base station to which the user terminal (10) is connected, extracts location information of the passenger according to the movement of a transportation means, and matches the location information with the boarding information received from the user terminal (10);
receives alighting information from the user terminal (10) when alighting is detected through communication between the short-range communication module of the passengers' user terminal (10) and the short-range communication module of the tagless device (20) installed at the station;
settles fare information based on a route-specific fare database using the boarding and alighting information and the location information; and
transmits the boarding and alighting information, the location information, and the settled fare information to a main server (30).

8. A tagless payment system based on linkage of mobile carriers' base stations, provided for public transportation means that allow transfers, the system comprising:
a user terminal (10) configured to perform wireless mobile communication with a mobile carriers' base station and including a short-range communication module for detecting boarding and alighting of a passenger;
a tagless device (20) installed at each station, including a short-range communication module configured to communicate with the user terminal (10) carried by the passenger to detect boarding and alighting of the passenger, and configured to transmit boarding and alighting information of the passenger to a main server (30);
a payment management apparatus (PS) including a processor, wherein the processor, by executing an application stored in a memory: receives information of mobile carriers' base station to which the user terminal (10) carried by the passenger is connected; extracts location information of the passenger according to the movement of a transportation means; matches the received boarding and alighting information from the user terminal (10) with the location information; settles fare information based on a route-specific fare database by using the boarding and alighting information and the location information; and transmits the boarding and alighting information, the location information, and the settled fare information to the main server (30); and
the main server (30) configured to receive and store the boarding and alighting information, the location information, and the settled fare information from the payment management apparatus (PS).

9. The tagless payment system based on linkage of mobile carriers' base stations according to claim 8,
wherein the tagless device (20) comprises:
an always-open gate (21) located inside a station and installed so as not to block the flow of passengers entering and exiting;
a plurality of short-range communication anchors (22) configured to locate the position of passengers in the station;
a tagless terminal (23) including a short-range communication module provided in the always-open gate (21) and configured to detect boarding and alighting of passengers; and
a positioning processor (24) configured to receive passenger location data detected through the short-range communication anchors (22) and boarding and alighting data of the passengers detected through the tagless terminal (23), and to transmit the data to a payment terminal (26) and the passengers' user terminal (10).
